(19) United States
(12) Patent Application Publication
(10) Pub. No.: US 2004/0230029 A1
(43) Pub. Date: Nov. 18, 2004

(54) Reactor and process for making amide plastics and super plastics

(76) Inventor: Joseph Mathias, Ridgeville (CA)

Correspondence Address: MARK A. KOCH, KOCH LAW OFFICE, 866 MAIN STREET EAST, HAMILTON, ON, L8M 1L9, CA

(21) Appl. No.: 10/693,864

(22) Filed: Oct. 28, 2003

Related U.S. Application Data
(60) Provisional application No. 60/428,689, filed on Nov. 25, 2002.

(51) Int. Cl. C08G 85/00

(52) U.S. Cl. 528/373; 528/396; 528/422; 528/425; 422/131; 422/134

(57) ABSTRACT

The present invention is a method of making amide and super plastics including the steps of dissolving hydrocarbon feed materials in a molten metal at temperatures above 400° C. and pressures above 400 kg/cm²; increasing the temperature to above 800° C. and the pressure to above 800 kg/cm² such that the feed material polymerizes together as an amide plastic; separating the amide plastic from the molten metal; and cooling the amide plastic and extracting amide plastic. Preferably wherein the molten metal is tin and the hydrocarbon feed materials are selected from the group comprised of oil, natural gas, sulfides of; sodium, potassium, magnesium, and zinc, salts of; bromine and chlorine, coal oils, propane, nitrogen, oxygen, urea, and hydrocarbon containing refuse.

### FIELD OF THE INVENTION

The present invention relates to methods and devices for making plastics and more particularly relates to a high temperature and pressure method and device for making amide plastics and super plastics.

### BACKGROUND OF THE INVENTION

There are a number of methods and apparatie that are currently used in order to formulate plastics of various types. All of these methods and devices each have their own draw backs, in terms of the cost to produce the plastic, the type of plastic that can be manufactured, the material feed that must be used in order to obtain certain plastic properties and finally, the quality and quantity of the plastic that can be manufactured with existing processes. Many current manufacturing techniques are specific to a given type of plastic or family of plastics and do not lend themselves to manufacture of other plastics or plastics with other properties. Many of the present plastic making techniques as well are limited in the feed material than can be used in order to produce the plastic. Therefore, there is need for a very flexible plastic manufacturing method and device which can use a variety of different feed materials and produce plastics and super plastics, having a variety of different properties and in large quantities and at a low cost.

### SUMMARY OF THE INVENTION

The present invention is a method of making amide and super plastics and includes the steps of:

(a) dissolving hydrocarbon feed materials in molten metal at temperatures above 400° C. and pressures above 400 kg/cm².

(b) increasing the temperature to above 800° C. and the pressure to above 800 kg/cm² such that said feed material polymerizes together as amide plastic.

(c) separating said amide plastic from said molten metal.

(d) cooling said amide plastic and extracting amide plastic.

The present invention is a method of making amide and super plastics and includes the steps of

(a) dissolving hydrocarbon feed materials in a molten metal at temperatures above 400° C. and pressures above 400 kg/cm²;

(b) increasing the temperature to above 800° C. and the pressure to above 800 kg/cm² such that said feed material polymerizes together as an amide plastic;

(c) separating said amide plastic from said molten metal; and

(d) cooling said amide plastic and extracting amide plastic.

Preferably where in the molten metal is tin.

Preferably wherein the hydrocarbon feed materials are selected from the group comprised of oil, natural gas, sulfides of; sodium, potassium, magnesium, and zinc, salts of; bromine and chlorine, coal oils, propane, nitrogen, oxygen, urea, and hydrocarbon containing refuse.

Preferably including a further step of preheating said feed materials prior to dissolving said feed materials in a molten metal.

Preferably wherein step (b) also includes increasing the temperature to above 800° C. and the pressure to above 800 kg/cm² such that said feed material polymerizes together as a super plastic;

The present invention also includes a reactor for making amide and super plastics comprising:

(a) a low temperature and pressure reactor vessel for receiving feed materials and dissolving said feed materials in molten metal;

(b) a high temperature and pressure reactor vessel for polymerizing said feed materials into amide plastics,

(c) a separator vessel for separating said molten metal from said amide plastic,

(d) means for introducing and communicating feed materials through the various reactor vessels.

Preferably further including a pre heater for pre heating feed material prior to introducing said feed material into said low temperature reactor vessel.

Preferably wherein said high temperature reactor housed within said low temperature reactor in order to minimize heat losses.

Preferably wherein said pre heater being a feed pre heater pipe housed within said separator vessel.

Preferably wherein said separator vessel including separate output valves for releasing amide plastic and super plastic respectively.

### BRIEF DESCRIPTION OF THE DRAWINGS

The present invention will now be described by way of example only with references to the following drawings in which:

FIG. 1 is a schematic cross sectional view of the reactor and processor for making amide and super amide plastics showing the reactor vessels and the material flow there through.

FIG. 2 is a schematic cross sectional side view of the combined reactor vessels showing the high temperature and pressure vessel housed within the low temperature and pressure vessel.

FIG. 3 is a cross sectional view of the combined reactor vessels showing the high temperature and pressure vessel nested and housed within the low temperature and pressure vessel.

FIG. 4 is a schematic flow diagram showing the steps involved in the method of making amide plastics and super plastics.

### DETAILED DESCRIPTION OF THE PREFERRED EMBODIMENT

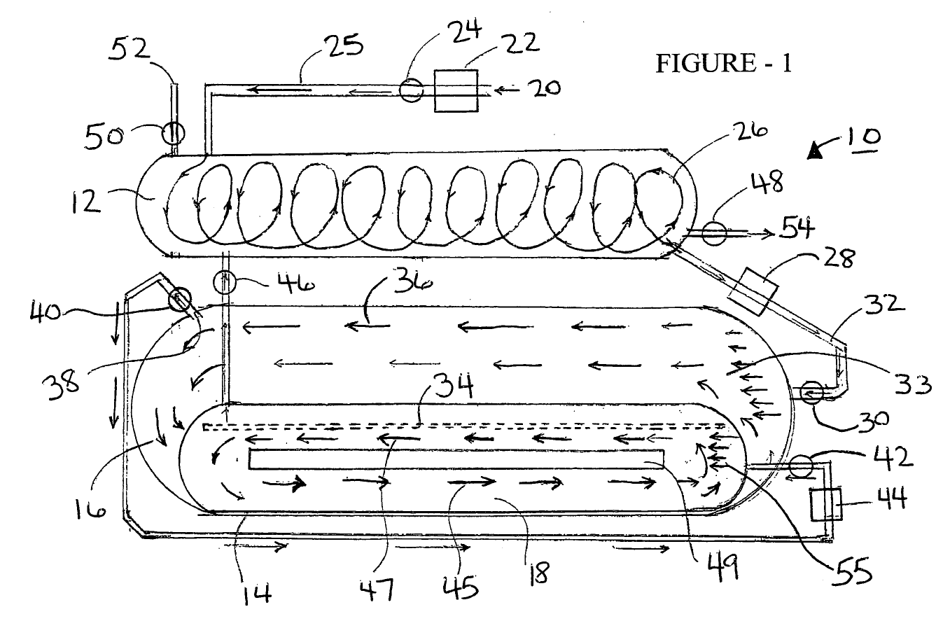

The present invention a reactor and process for making amide plastics and super plastics is depicted schematically in FIG. 1. The apparatus for making amide and super plastics is shown in FIG. 1 as a number of interconnected reactor vessels denoted generally as 10. The reactor for making amide plastics and super plastics, consists of reactor vessels 10 which are interconnected and described as here below. Reactor vessels 10 include the following major components, namely separator vessel 12, combined reactor vessels 14, which include low temperature and pressure vessel 16 and high temperature and pressure vessel 18.

The components of reactor vessels 10 will now be described by following the material flow through the various vessels.

Raw material feed 20 is fed through feed pump 22 and controlled by feed valve 24 through feed pipe 25 which winds its way through separator vessel 12 as preheated feed pipe 26. Raw material feed 20 is then injected into low temperature and pressure vessel 16, via feed injector pump 28, through feed injector pipe 32 and controlled by feed injector valve 30. Material feed is injected into low temperature and pressure vessel 16 through injector nozzles 33 and is circulated through low temperature and pressure vessel 16, along circulation directions denoted as 36 in a circular motion around partition 34.

Material then leaves low temperature and pressure vessel 16 via outlet 38 and is controlled by outlet valve 40 and is fed through inlet pump 44 and controlled by inlet valve 42 and enters into high temperature and pressure vessel 18. From there the material feed circulates around partition 49 in circulation directions 47 and 45 as indicated in FIG. 1.

From there material is fed through transfer valve 46 into separator vessel 12, wherein plastics are extracted from separator vessel 12 wherein output valve 50 controls amide plastic output 52 and output valve 48 controls super plastic output 54.

It should be noted that FIG. 1 is strictly a schematic diagram indicating how material flow would occur through reactor vessels 10. A person skilled in the art naturally would recognize that separator vessel 12, low temperature and pressure vessel 16 as well as high temperature and pressure vessel 18 and interconnecting piping, valving and pumps would have to be manufactured from materials that are able to withstand the high temperatures and pressures required within these vessels and pipes. Materials would be selected to minimize oxidation and corrosion of the interior walls of the vessels. By way of example only without limiting the possible material selections, the interior of low temperature and pressure vessel 16 and high temperature and pressure vessel 18 as well as separator vessel 12 may in practice be coated with silicon nitride in order to prevent rapid corrosion and decay of the reactor vessels. The silicon nitride would also act as a insulating material.

In Use

Referring now to FIGS. 1, 2 and 3, raw material feed 20 as depicted in FIG. 1 is fed via a feed pump 22 and controlled with a feed valve 24 into a preheated feed pipe 26 which makes its way through separator vessel 12, thereby preheating the raw material feed 20 as it makes it way through separator vessel 12. Those skilled in the art will see that combined reactor vessels 14 include a low temperature and pressure vessel 16 being the larger of the two having housed therein a smaller high temperature and pressure vessel 18. This arrangement is not absolutely necessary but only depicts the preferred or current best mode. Placing the high temperature and pressure vessel 18 within low temperature and pressure vessel 16, has the advantage of lowering the pressure and temperature differential between the inside and outside of high temperature and pressure vessel 18, thereby lowering both the thermal and mechanical stress on high temperature and pressure vessel 18 and also creating a more heat and pressure efficient system.

Raw material feed 20 may include hydrocarbons such as high sulphur oils and gases which can be petroleum products and/or coal by products. Raw material feed can also include sylphids of sodium, potassium, magnesium or zinc; and fluorine, chlorine or bromine salts of the same metals, in addition to urea and various alcohols. The selection of the proportion of the various materials depends upon the properties and the type of plastic one wishes to produce. For example the higher the urea sulphide and salt content, the stronger and the harder the plastics become. Generally speaking urea makes plastic resilient, fluorides with sodium make it light, smooth and slippery and additions of alcohol and oxygen make it rubbery and elastic and sticky.

Those skilled in the art in producing amide plastics and super plastics are familiar with the various properties of amide plastics and super plastics that can be manufactured and the effects of the raw material proportions have on the final properties of the plastics produced.

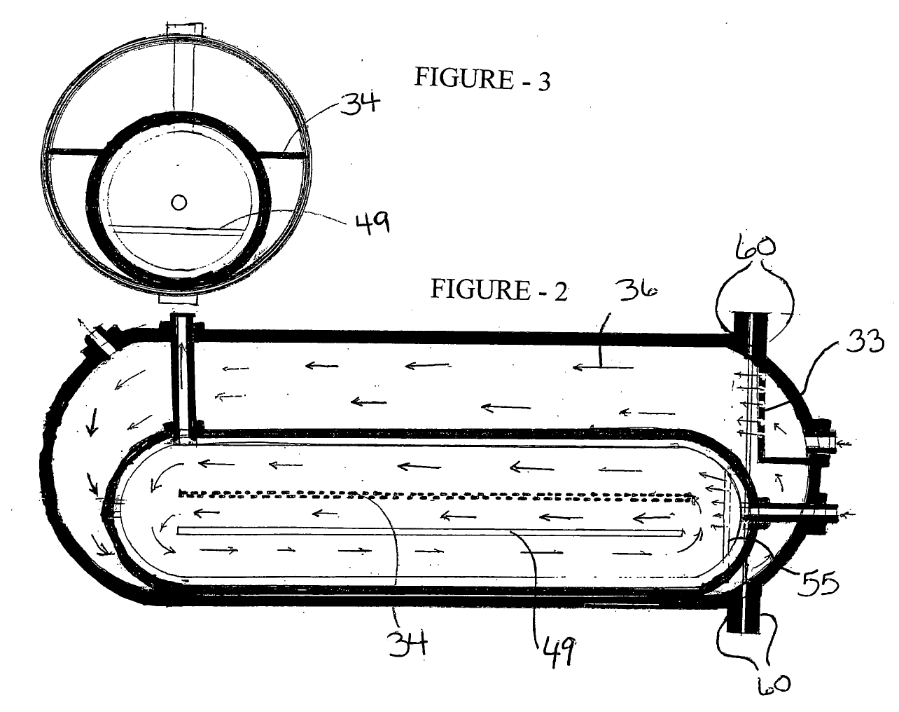

Low temperature and pressure vessel 16 is preferably maintained at a temperature of around 800° C. and at a pressure of 800 kg/cm². Raw material feed 20 is preheated in separator vessel 12 as it coils through a preheated feed pipe 26 and is injected into low temperature and pressure vessel 16 via feed injector pump 28 and controlled by feed injector valve 30 and is injected through injector nozzle 33 into low temperature and pressure vessel 16. The feed material within low temperature and pressure vessel 16 is raised to a temperature to around 800° C. and is maintained at a pressure of roughly 800 kg/cm² and circulates in a circular fashion around partition 34 in circulation direction 36 as shown in FIG. 1 and also in FIG. 2. The raw material feed is converted into molecules and solution polymerizes the feed into amide plastics with molten tin as a solvent and polymerizer. The process uses high temperature and pressure with catalysts in a molten metal such as tin to dissolve organic materials as molecules which absorb heat and then polymerize them together as amide plastics. Metals other than tin can also be utilized depending upon the properties and reactor temperatures. The feed material is then transferred at outlets 38 via outlet valve 40 into a high temperature and pressure vessel 18, via inlet pump 44, inlet valve 42 and injector nozzle 55 which injects the feed material into high temperature and pressure vessel 18.

High temperature and pressure vessel 18, preferably is maintained at around 1500° C. and 1500 kg/cm² of pressure. This vessel is preferably insulated and coated with silicon nitride to avoid corrosion and erosion problems of the hot tin contained within these reaction vessels.

Low temperature and pressure vessel 16 is sealed at flanges 60 through customary means in the art, including bolts, rivets and the like.

Feed material is circulated in circulation direction 47 and 45 as indicated in FIG. 1 in a circular motion around partition 49.

Feed material then is transferred into separator vessel 12 where the temperature and pressure is reduced, such that amide plastics are extracted from separator vessel 12 at amide plastic output 52 which is controlled by outlet valve 50 and superplastics are extracted from separator vessel 12 at super plastic output 54 which is controlled by outlet valve 48. The amide plastics tend to flow to the top and therefore are drawn out near the top of separator vessel 12 whereas the super plastics tend to remain at the bottom and are removed near or approximate the lower part of separator vessel 12 and are extracted there.

In order to withstand the temperatures, pressures and the corrosion requirements, it may be necessary that the tanks and pipes of reactor vessels 10 may be made out of titanium or coated with ceramic coatings such as silicon nitride or other coatings and/or materials known in the art to be able to withstand the conditions with reactor vessels 10.

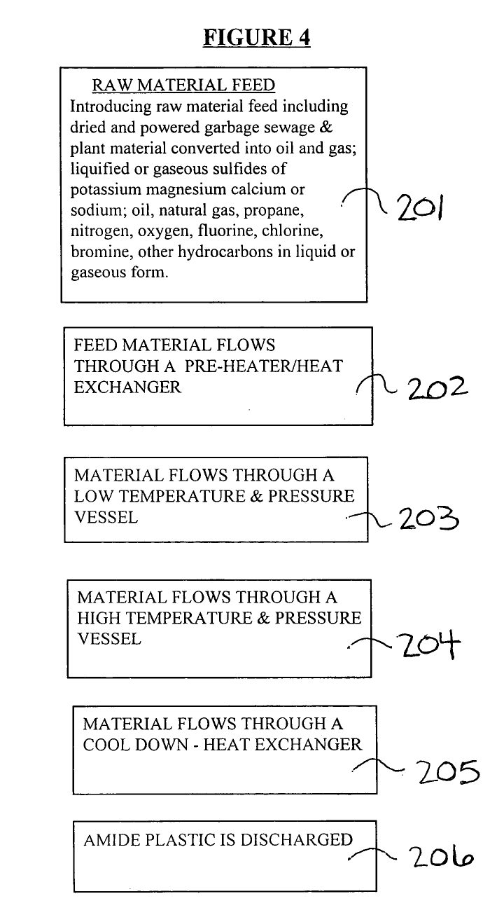

The process is shown schematically in FIG. 4 in which Step 1 shown generally as 201 includes:

Introducing raw material feed including dried and powdered garbage sewage & plant material converted into oil and gas; liquified or gaseous sulfides of potassium magnesium calcium or sodium; oil, natural gas, propane, nitrogen, oxygen, fluorine, chlorine, bromine, other hydrocarbons in liquid or gaseous form.

Step 2 shown generally as 202 includes:

Feed material flows through a pre-heater/heat exchanger

Step 3 shown generally as 203 includes:

Material flows through a low temperature & pressure vessel

Step 4 shown generally as 204 includes:

Material flows through a high temperature & pressure vessel

Step 5 shown generally as 205 includes:

Material flows through a cool down—heat exchanger

Step 6 shown generally as 206 includes:

Amide plastic is discharged

It should be apparent to persons skilled in the arts that various modifications and adaptation of this structure described above are possible without departure from the spirit of the invention the scope of which defined in the appended claim.

I claim:

1. A method of making amide and super plastics including the steps of:
(a) dissolving hydrocarbon feed materials in a molten metal at temperatures above 400° C. and pressures above 400 kg/cm²;
(b) increasing the temperature to above 800° C. and the pressure to above 800 kg/cm² such that said feed material polymerizes together as an amide plastic;
(c) separating said amide plastic from said molten metal; and
(d) cooling said amide plastic and extracting amide plastic.

2. The method claimed in claim 1 wherein the molten metal is tin.

3. The method claimed in claim 1 wherein the hydrocarbon feed materials are selected from the group comprised of oil, natural gas, sulfides of; sodium, potassium, magnesium, and zinc, salts of; bromine and chlorine, coal oils, propane, nitrogen, oxygen, urea, and hydrocarbon containing refuse.

4. The method claimed in claim 1 including a further step of preheating said feed materials prior to dissolving said feed materials in a molten metal.

5. The method claimed in claim 1 wherein step (b) also includes increasing the temperature to above 800° C. and the pressure to above 800 kg/cm² such that said feed material polymerizes together as a super plastic;

6. A reactor for making amide and super plastics comprising:
(a) a low temperature and pressure reactor vessel for receiving feed materials and dissolving said feed materials in molten metal;
(b) a high temperature and pressure reactor vessel for polymerizing said feed materials into amide plastics,
(c) a separator vessel for separating said molten metal from said amide plastic,
(d) means for introducing and communicating feed materials through the various reactor vessels.

7. The reactor claimed in claim 6 further including a pre heater for pre heating feed material prior to introducing said feed material into said low temperature reactor vessel.

8. The reactor claimed in claim 6 wherein said high temperature reactor housed within said low temperature reactor in order to minimize heat losses.

9. The reactor claimed in claim 7 wherein said pre heater being a feed pre heater pipe housed within said separator vessel.

10. The reactor claimed in claim 6 wherein said separator vessel including separate output valves for releasing amide plastic and super plastic respectively.
